(19) United States
(12) Patent Application Publication
(10) Pub. No.: US 2026/0206727 A1
(43) Pub. Date: Jul. 23, 2026

(54) AUTOMATIC FISH FOOD DISPENSING DEVICE

(71) Applicant: Jiao Xu, Shenzhen (CN)

(72) Inventor: Jiao Xu, Shenzhen (CN)

(21) Appl. No.: 19/454,294

(22) Filed: Jan. 20, 2026

(30) Foreign Application Priority Data
Jan. 20, 2025 (CN) 202520132672.1

(51) Int. Cl. A01K 61/85; A01K 63/06; H02K 5/22

(52) U.S. Cl. CPC A01K 61/85; A01K 63/065; H02K 5/225

(57) ABSTRACT

An automatic fish food dispensing device is provided, including a storing container, a heater, and a dispensing mechanism. The storing container is for storing fish food. The heater is for heating to keep the fish food dry. The dispensing mechanism configured to control the dispensing of the fish food from the storing container.

### RELATED APPLICATIONS

This application claims the benefit of priority to Chinese Patent Application Number 202520132672.1 filed on January 20, 2025, in the China National Intellectual Property Administration. The entire contents of the above-identified application is hereby incorporated by reference.

### Technical Field

The present disclosure relates to the technical field of fish food dispensing, and more particularly, to an automatic fish food dispensing device installable on a fish tank.

### Background Art

When raising ornamental fish, regular and periodic feeding is required. Overfeeding at once may cause the fish to overeat and die, while not feeding for an extended period may lead to starvation. Therefore, automatic fish food dispensing devices have been developed and applied.

An automatic fish food dispensing device is installed on a fish tank. It can hold a certain amount of fish food and automatically dispense the food into the tank according to preset conditions, offering great convenience. However, users may desire more reliable automatic dispensing devices.

### BRIEF DESCRIPTION OF DRAWINGS

To illustrate technical solutions in embodiments of the present disclosure more clearly, the following briefly introduces accompanying drawings used in the description of the embodiments. Obviously, the accompanying drawings in the following description are only some embodiments of the present disclosure. Those of ordinary skill in the art can obtain other accompanying drawings from these accompanying drawings without any creative efforts.

FIG. 1 is a perspective view of an automatic fish food dispensing device according to a first embodiment of the present disclosure.

FIG. 2 is an internal structural view of the automatic fish food dispensing device shown in FIG. 1.

FIG. 3 is an exploded view of the automatic fish food dispensing device shown in FIG. 1.

FIG. 4 is a perspective view of an automatic fish food dispensing device according to a second embodiment of the present disclosure.

FIG. 5 is an internal structural view of the automatic fish food dispensing device shown in FIG. 4.

FIG. 6 is an exploded view of the automatic fish food dispensing device shown in FIG. 4.

FIG. 7 is an internal structural view of an automatic fish food dispensing device according to a third embodiment of the present disclosure.

FIG. 8 is an exploded view of the automatic fish food dispensing device according to the third embodiment.

FIG. 9 is an internal structural view of an automatic fish food dispensing device according to a fourth embodiment of the present disclosure.

FIG. 10 is a perspective view of an automatic fish food dispensing device according to a fifth embodiment of the present disclosure.

FIG. 11 is a cross-sectional view of the automatic fish food dispensing device shown in FIG. 10.

FIG. 12 is an exploded view of the automatic fish food dispensing device according to the fifth embodiment.

FIG. 13 is a perspective view of a first coupling shown in FIG. 12.

FIG. 14 is a perspective view of a second coupling shown in FIG. 12.

FIG. 15 is a perspective view of a third coupling shown in FIG. 12.

FIG. 16 is a perspective view of the third coupling, viewed from another angle.

FIG. 17 is a perspective view of an end cap shown in FIG. 12.

FIG. 18 is a schematic diagram showing a state of the automatic fish food dispensing device of the present disclosure, the automatic fish food dispensing device is installed on an fish tank.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

The inventor has discovered that continuous evaporation of water from a fish tank 200 creates a humid microenvironment around it. Traditional dispensers can develop condensation inside due to diurnal temperature changes or environmental fluctuations, causing the food to become damp, clump, or even mold. This can block the outlet or dispense harmful food. The automatic fish food dispensing device 100 of the present disclosure can actively maintain a relatively dry state inside the storing container 10, effectively inhibiting the formation of condensation. This ensures the fish food remains dry, loose, and free-flowing. It fundamentally avoids dispensing failures, device damage, and health risks to fish caused by damp food, making the automatic dispensing process more stable and reliable, greatly satisfying the user's core need for long-term stable operation of the equipment.

The automatic fish food dispensing device 100 of the present disclosure configured to be installed on a fish tank 200 for automatically dispensing fish food, the automatic fish food dispensing device 100 comprises a storing container 10 configured to contain fish food, the storing container 10 includes a first housing 1, and a dispensing mechanism 70 configured to control dispensing of the fish food from the storing container 10. The dispensing mechanism 70 includes a second housing 12 wherein an interior cavity of the second housing 12 is isolated from an interior cavity of the first housing 1. The interior cavity of the second housing 12 is isolated from the interior cavity of the first housing 1. This structural isolation ensures that the components such as a power system 60, controller 30, and motor 40, which are housed within the dry, protected environment of the second housing 12, are completely shielded from the humid atmosphere of the fish food storage area within the first housing 1. This effectively prevents moisture and condensation from compromising the electronic components, thereby guaranteeing the long-term stability and reliability of the dispensing mechanism 70. The power system 60, controller 30, and motor 40 are in the second housing 12. The power system 60 being configured to provide power to the dispensing mechanism 70. A heater 20 thermally coupled to the first housing 1 and being configured to generates enough heat to maintain the fish food inside the first housing 1 in a dry condition. Specific implementation schemes are detailed below.

### Embodiment 1

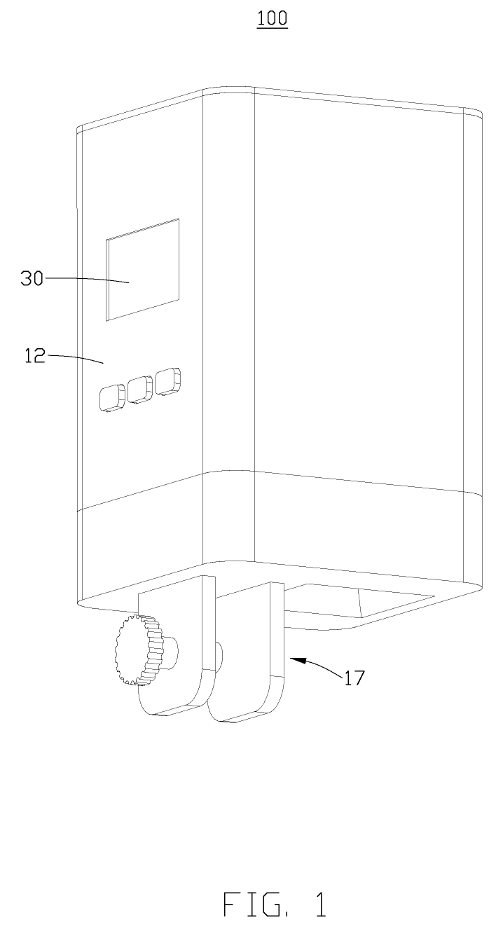

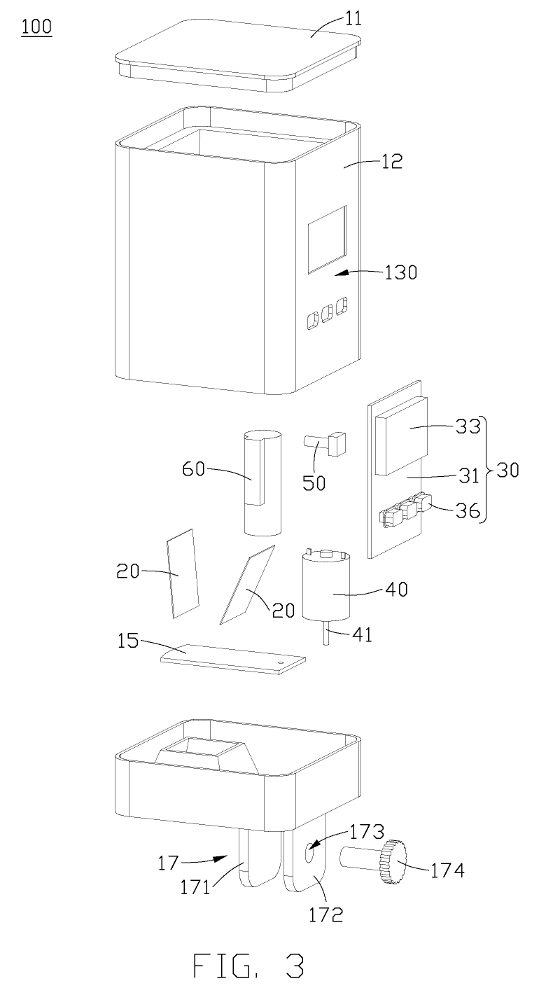

As shown in FIGS. 1 to 3, the automatic fish food dispensing device 100 includes a storing container 10 and a dispensing mechanism 70. A first housing 1 as a part of a storing container 10 for storing fish food. An inner wall of the first housing 1 is provided with a heated wall 101 for heating the storing container 10 to remove moisture, thereby keeping the stored fish food dry. The heater 20 is laid over an entire surface of the heated wall 101 of the storing container 10 to heat the heated wall 101. The dispensing mechanism 70 includes a controller 30, the controller 30 is electrically connected to the heater 20 to control the heater 20 for heating, thereby evaporating moisture within the storing container 10 and keeping the fish food dry. The storing container 10 is further provided with an outlet 13 formed therein for dispensing fish food.

In this embodiment, the first housing 1 has a structure with openings on two sides: one opening is a feeding port, and the other is the outlet 13. The feeding port is above, and the outlet 13 is below. The feeding port is used for loading fish food into the storing container 10, and the fish food in the storing container 10 can fall into the fish tank 200 through the outlet 13. The first housing 1 also includes a lid 11 for closing the feeding port of the storing container 10. The storing container 10 is formed inside the first housing 1 and includes oppositely arranged a first sloped wall 102 and a second sloped wall 104. The first sloped wall 102 and the second sloped wall 104 are spaced apart and inclined, so that the distance between them increases farther away from the outlet 13. One end of the first sloped wall 102 and the second sloped wall 104 is connected to the feeding port, and the other end is connected to the outlet 13, thereby guiding the food along the inclined walls to the outlet 13.

Areas of the first sloped wall 102 and the second sloped wall 104 near the outlet 13 constitute the heated wall 101. In other words, the heated wall 101 is a portion of the first sloped wall 102 and the second sloped wall 104 close to the outlet 13. The heater 20 is laid over the entire surface of the heated wall 101 to increase the heating area, thereby quickly heating the food located at the heated wall 101.

Furthermore, in this embodiment, the heater 20 is arranged on an outer side of the heated wall 101, but this is not limiting. It can also be arranged on an inner side of the heated wall 101, designed according to actual needs. Also, in this embodiment, the heated wall 101 is part of the first sloped wall 102 and the second sloped wall 104, but not limited thereto. The heated wall 101 can also be the entire surface of the first sloped wall 102 and the second sloped wall 104. Moreover, in this embodiment, the heated wall 101 is provided on the first sloped wall 102 and the second sloped wall 104, but not limited thereto. All or part of the walls of the storing container 10 can be arranged as the heated wall 101.

Additionally, in this embodiment, the heated wall 101 is integrally formed from the same material as the first sloped wall 102 and the second sloped wall 104. However, it is not limited thereto. For example, when the heater 20 is arranged on the outer side of the heated wall 101, the heated wall 101 can be made of a thermally conductive material to improve heat conduction efficiency and thus heating efficiency.

Moreover, in this embodiment, the heater 20 can include a sheet-like heating structure, such as a carbon fiber heating sheet, graphene heating fabric, ceramic PTC heating sheet, etc. Furthermore, the heater 20 can be at least one of a sheet structure constituted by an entire heating sheet, a sheet structure formed by laying heating tubes, and a sheet structure formed by laying heating wires.. The structure and shape of the heater 20 are not limited hereto. In other embodiments, for example, the heater 20 can also be a warm air device. The heating temperature of the heater 20 is typically set between 40°C and 60°C. Thus, by using the heater 20 to heat the heated wall 101, the fish food stored in the storing container 10 can be heated efficiently over a large area, effectively evaporating moisture and keeping the fish food dry.

The dispensing mechanism 70 further includes a controller 30 in the second housing 12. The controller 30 includes a PCB 31, a display 33, and a plurality of buttons 36 provided on the PCB 31. The PCB 31 is installed inside the second housing 12 and is electrically connected to the heater 20 to control it. The display 33 is positioned on an outer surface of the second housing 12 to show various heating information to the user. The plurality of buttons 36 are provided on the outer surface of the second housing 12 and connected to the PCB 31. The user can use these buttons 36 for various settings, such as setting feeding schedules, heating timers for the heater 20, etc., to configure various modes.

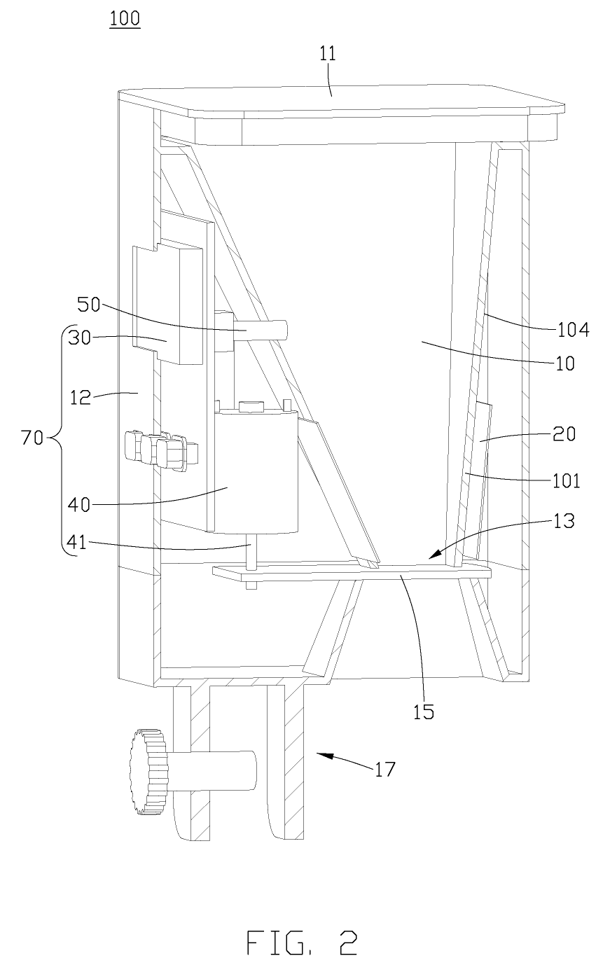

Furthermore, dispensing mechanism 70 further includes a motor 40 electrically connected to the controller 30. As shown in FIG. 2, a drive shaft 41 of the motor 40 is connected to a shutter 15 of the storing container 10 to drive the shutter 15 to open or close the outlet 13. Thus, when feeding is required according to a preset schedule, the controller 30 controls the shutter 15 to open the outlet 13, allowing food to fall into the fish tank 200. The opening/closing of the shutter 15 can be preset by the user, e.g., once a day or multiple times a day, designed according to actual needs.

The automatic fish food dispensing device 100 also includes a humidity sensor 50 electrically connected to the controller 30. It protrudes into the interior of the first housing 1 to detect humidity inside. Moreover, the humidity sensor 50 is located closer to a central portion of the first housing 1 than the heater 20, so that the data it monitors more accurately reflects the maximum humidity within the storing container 10.

When the detected humidity inside the storing container 10 reaches a preset threshold (e.g., 60%), even if a preset heating timer has not expired, the controller 30 automatically controls the heater 20 to heat, ensuring the fish food remains dry.

The automatic fish food dispensing device 100 further includes a power system 60, preferably a rechargeable lithium battery. The power system 60 is electrically connected to the PCB 31. Therefore, the user can charge the power system 60 at any time based on the battery level displayed on the display 33, achieving energy saving and environmental protection. Additionally, the power system 60 is electrically connected to the heater 20, controller 30, motor 40, and humidity sensor 50 to power them.

Furthermore, the automatic fish food dispensing device 100 includes a mount 17. The mount 17 extends vertically from a bottom of the second housing 12 and includes oppositely arranged a first clamp plate 171, a second clamp plate 172, and a bolt 174. The second clamp plate 172 has a threaded hole 173. The bolt 174 passes through the threaded hole 173 and can abut against the other clamp plate 171. Thus, for example, the device 100 can be fixed onto fish tanks of various thicknesses (various types) via the mount 17, greatly improving convenience. The structure of the mount 17 is not limited hereto, as long as it can stably fix the device 100 onto a fish tank 200.

Thus, according to the automatic fish food dispensing device 100 of this embodiment, users can preset feeding controls (e.g., feeding frequency, schedule, amount) and heating controls (heating schedule, duration) separately based on their situation, or combine them, e.g., heating with the heater 20 for a set time before each feeding. This allows automatic feeding when the user is traveling or away. Of course, users can also directly control heating and feeding manually for enjoyment.

Through heating by the heater 20 maintaining the fish food in a dry and fresh state for a long time and greatly improving moisture resistance.

### Embodiment 2

For ease of explanation, components introduced in Embodiment 1 are labeled with the same reference numerals in this embodiment and subsequent ones.

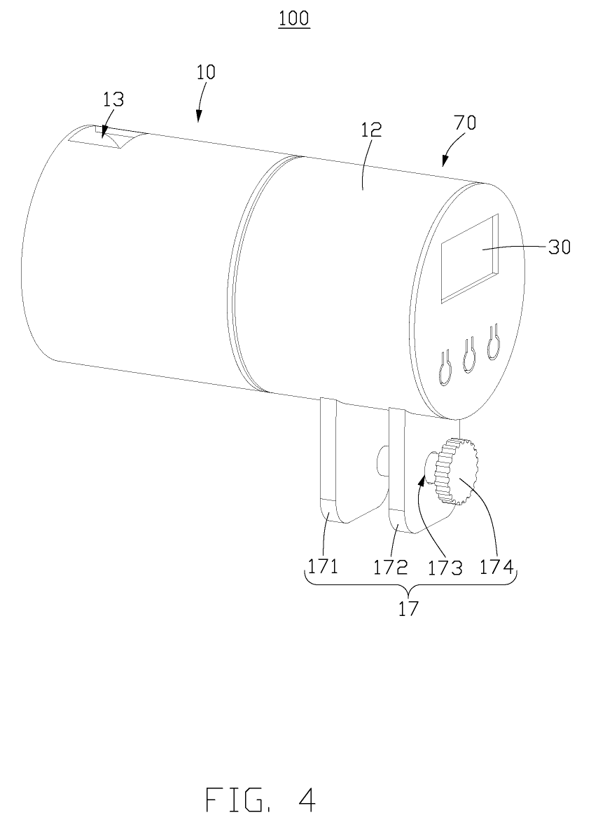

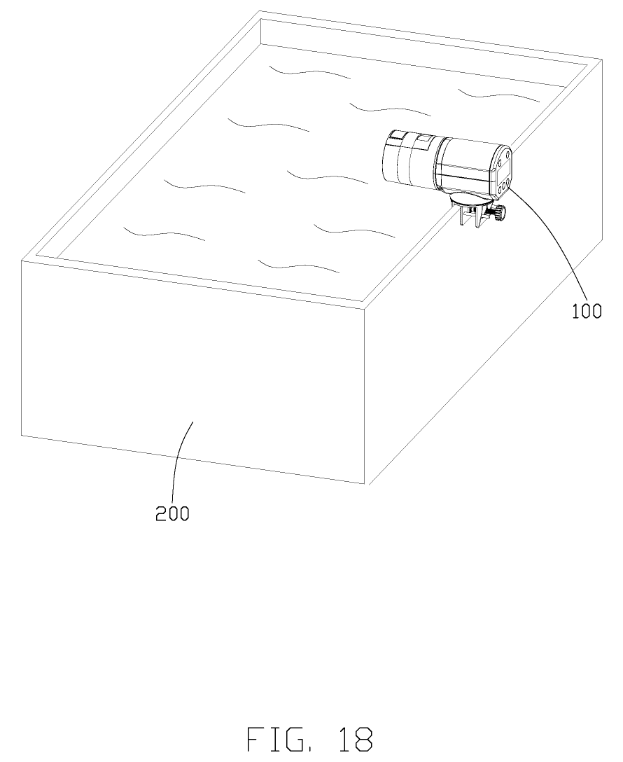

Referring to FIGS. 4 to 6 and FIGS. 18, in this embodiment, the first housing 1 rotatably connected to the second housing 12.

In this embodiment, the first housing 1 has a cylindrical structure, and both the heated wall 101 and the outlet 13 are formed on its cylindrical wall. The heated wall 101 is located opposite the outlet 13, spaced apart from it. The structure of the first housing 1 is not limited hereto; it can also be rectangular or elliptical, etc.

In this embodiment, the heated wall 101 is arranged opposite the outlet 13. When the outlet 13 faces downward for dispensing (the first housing 1 in a second state described below), the heater 20 is located above the outlet 13 and does not affect food dispensing. Moreover, when the outlet 13 faces upward (the first housing 1 in a first state described below), the heater 20 is positioned below the outlet 13 and at the bottom of the storing container 10. When the storing container 10 stores fish food, the heater 20 is at the bottom of the food, so the heat generated not only keeps the fish food near the outlet 13 dry but also more thoroughly dries all the fish food in the first housing 1.

In this embodiment, the first housing includes oppositely arranged a first wall 103 and a second wall 105. The first wall 103 serves as the heated wall 101. The heater 20 is curved and applied over the entire curved surface of the first wall 103. The second wall 105 is provided with the outlet 13 formed therein. In this embodiment, the heater 20 is applied to an inner surface of the heated wall 101, and its surface is made of a material that can directly contact the fish food, such as ceramic.

One end of the first housing 1 facing the second housing 12 is an open end, and an end cap 14 is provided at the open end to isolate the first housing 1 from the second housing 12. The motor 40 installed inside the second housing 12 and connected to the first housing 1 and the controller 30. Under control of the controller 30, the motor 40 can drive the first housing 1 to rotate relative to the second housing 12, causing the fish food to fall into the fish tank 200.

An end of the first housing 1 facing the second housing 12 is snap-connected to the end cap 14. The end cap 14 is fixedly connected to a coupling 90. The coupling 90 is fixedly connected to the drive shaft 41 of the motor 40. The motor 40 is also connected to the controller 30, so that under its control, the motor 40 can drive the end cap 14 and the first housing to rotate together.

In this embodiment, when dehumidification of the fish food is needed, the motor 40 drives the first housing 1 to rotate to the first state, where the first wall 103 is below the second wall 105. When feeding is needed, the motor 40 drives the first housing 1 to rotate to the second state, where the second wall 105 is below the first wall 103, so that the fish food in the first housing falls into the fish tank 200 via the outlet 13. When not feeding, the first housing 1 is kept in the first state.

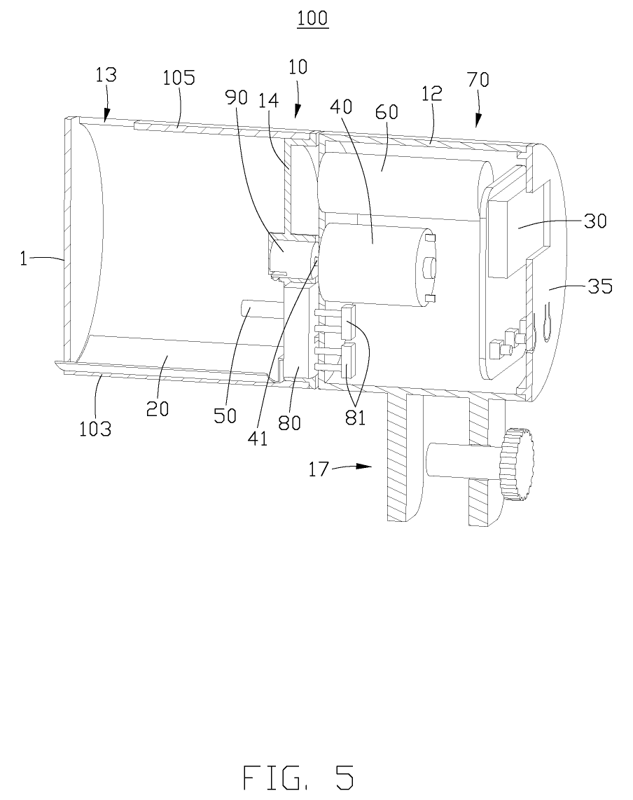

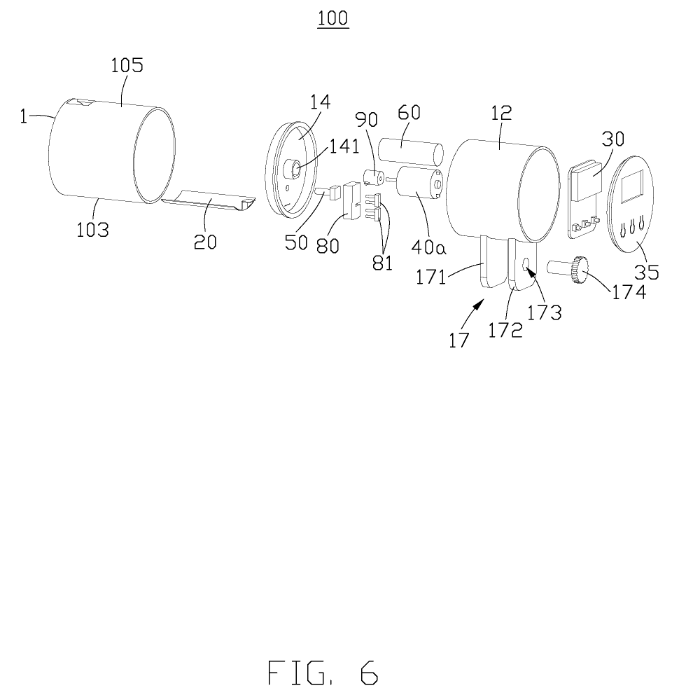

The second housing 12 also has a pogo pin connector 81 connected to the controller 30. The end cap 14 is provided with a connector board 80 (e.g., a PCB) capable of electrically connecting to the pogo pin connector 81. The connector board 80 is fixedly and electrically connected to the humidity sensor 50 and the heater 20. The humidity sensor 50 protrudes into the first housing 1 to detect humidity or directly contact the fish food. The pogo pin connector 81 is fixedly connected to the second housing 12 and does not rotate with the first housing 1. The humidity sensor 50, heater 20, and connector board 80 can rotate with the first housing 1. When the motor 40 drives the first housing 1 to the first state, the connector board 80 electrically connects with the pogo pin connector 81, thereby also connecting the heater 20 and humidity sensor 50 to it. Thus, in the first state, the controller 30 can heat and monitor humidity for the fish food. Similarly, the humidity sensor 50 is located closer to the central portion of the first housing 1 than the heater 20, so its data more accurately reflects the maximum humidity. FIGS. 5 and 6 show the pogo pin connector 81 having four spring conductive pins. The connector board 80 contacts the pins once per rotation of the first housing 1. FIG. 5 shows the first housing 1 in the first state, with the connector board 80 contacting the pins, establishing electrical connection. When the first housing 1 is in the second state, the connector board 80 disconnects from the pins.

### Embodiment 3

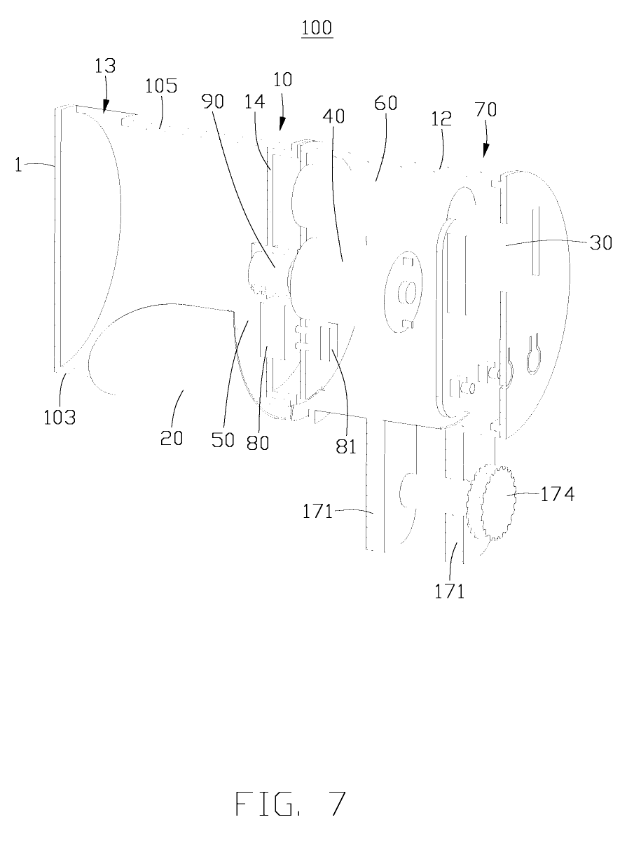

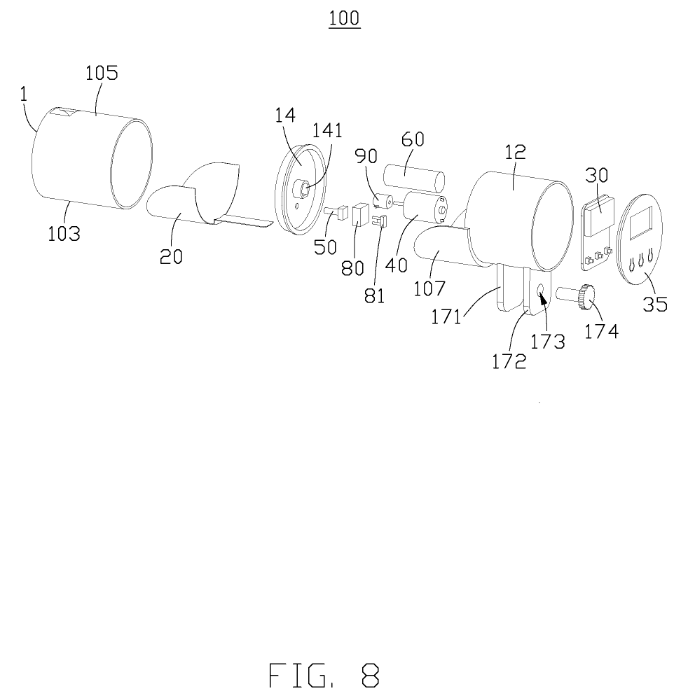

As shown in FIGS. 7 and 8, the difference from Embodiment 2 is that in this embodiment, the heater 20 is located outside the first housing 1, adjacent to an outer surface of the heated wall 101. A third cover plate 107 extends from one end of the second housing 12, covering at least a portion of the first housing 1. The heater 20 is carried on the third cover plate 107 and is completely covered by it, with the plate 107 being slightly larger than the heater 20. Thus, heat generated by the heater 20 first raises the temperature of the storing container's wall. Fish food contacting the inner wall is heated at a rate that is not too fast.

In this embodiment, when the motor 40 drives the first housing 1 to rotate, the heater 20 located outside does not rotate. Therefore, both the first wall 103 and the second wall 105 can serve as heated walls. Moreover, referring to FIG. 7, when the first housing 1 rotates to the first state, the heater 20 is opposite the outlet 13. When it rotates to the second state, the heater 20 does not cover the outlet 13.

Similarly, in this embodiment, the humidity sensor 50 is located closer to the central portion of the storing container 10 than the heater 20, so its data more accurately reflects the maximum humidity.

In this embodiment, FIGS. 7 and 8 show the pogo pin connector 81 having two spring conductive pins. Similarly, the connector board 80 contacts the pins once per rotation. FIG. 7 shows the first housing 1 in the first state, with connection established. When in the second state, the connection is broken. In fact, in this embodiment, since the heater 20 does not rotate, it may also be directly connected to the controller 30 without passing through the pogo pin connector 81. In that case, the controller 30 can control the heater 20 to heat whether the first housing 1 is in the first or second state.

### Embodiment 4

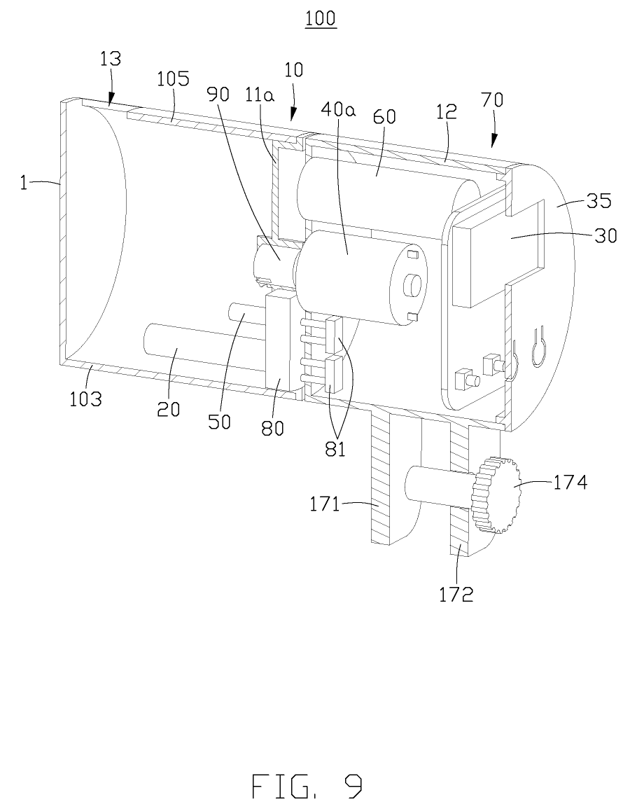

As shown in FIG. 9, the difference from Embodiment 2 is that in this embodiment, the heater 20 is configured not to directly contact the wall of the storing container 10, specifically spaced apart from the first wall 103 by a certain distance but still adjacent to it. The heater 20 is configured as a tubular shape but not limited thereto; it can be other shapes. When the controller 30 controls the heater 20 to heat, it directly heats the surrounding fish food. Similarly, the surface of the heater 20 is made of a material that can directly contact the fish food.

Thus, with such an arrangement, the fish food stored in the first housing 1 can also be efficiently heated, effectively reducing dampness and clumping, thereby maintaining the fish food in a dry, fresh state for a long time and improving moisture resistance.

Similarly, the humidity sensor 50 is located closer to the central portion of the first housing 1 than the heater 20, so its data more accurately reflects the maximum humidity.

Furthermore, in this embodiment, FIG. 9 shows the pogo pin connector 81 having four spring conductive pins. Similarly, the connector board 80 contacts the pins once per rotation. FIG. 9 shows the first housing 1 in the first state, with connection established. When in the second state, the connection is broken.

### Embodiment 5

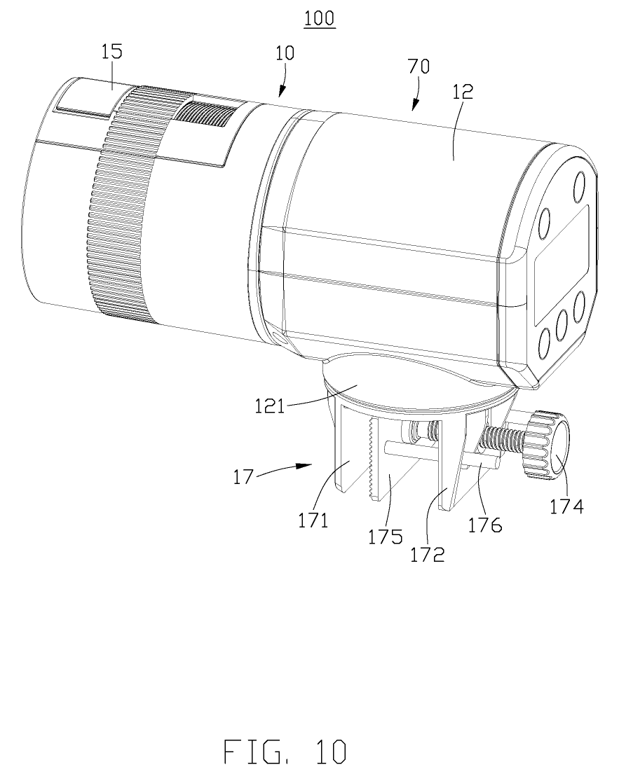

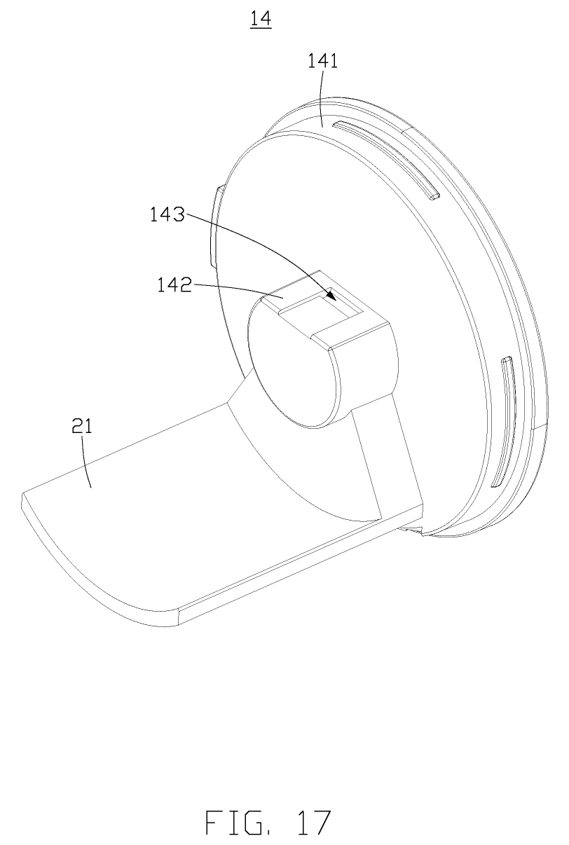

Referring to FIGS. 10 to 17, the difference from Embodiment 2 is that in this embodiment, the first housing 1 is provided with a shutter 15. The shutter 15 includes a first shutter 151, a second shutter 152, and a third shutter 153. The first shutter 151 is fixedly installed near the outlet 13 of the storing container 10 to block a portion of the outlet 13. The first shutter 151 has a shutter opening 154 smaller than the outlet 13. Fish food in the first housing 1 passes sequentially through the unblocked portion of the outlet 13 and the shutter opening 154, finally falling into the fish tank 200. The second shutter 152 is slidably connected to the first shutter 151. By sliding the second shutter 152, the size of the shutter opening 154 can be adjusted, thereby regulating the food flow rate. The third shutter 153 is rotatably connected to the first shutter 151. When the first housing 1 is in the second state, the third shutter 153 opens the shutter opening 154 under gravity, allowing food to fall under gravity. When the first housing 1 is in the first state, the third shutter 153 covers the shutter opening 154 under gravity. This helps seal the outlet 13 in the first state, reducing the possibility of external moisture entering the first housing 1 through the outlet 13.

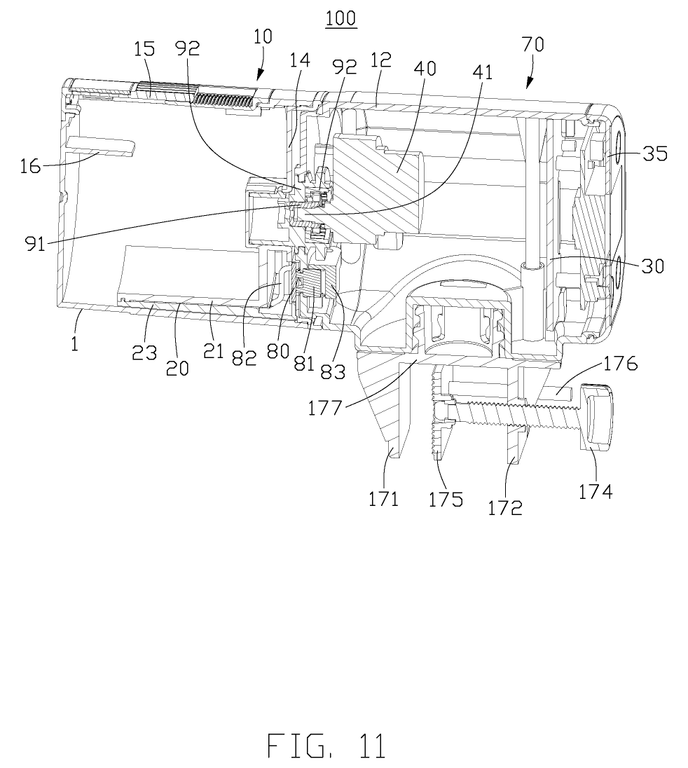

Referring to FIG. 11, in this embodiment, a baffle 16 is also positioned near the outlet 13 of the first housing 1. It can slow down the rush of food toward the outlet 13, preventing clogging and achieving a more uniform, controllable dispensing flow.

Similarly, the humidity sensor 50 is located closer to the central portion of the first housing 1 than the heater 20, so its data more accurately reflects the maximum humidity.

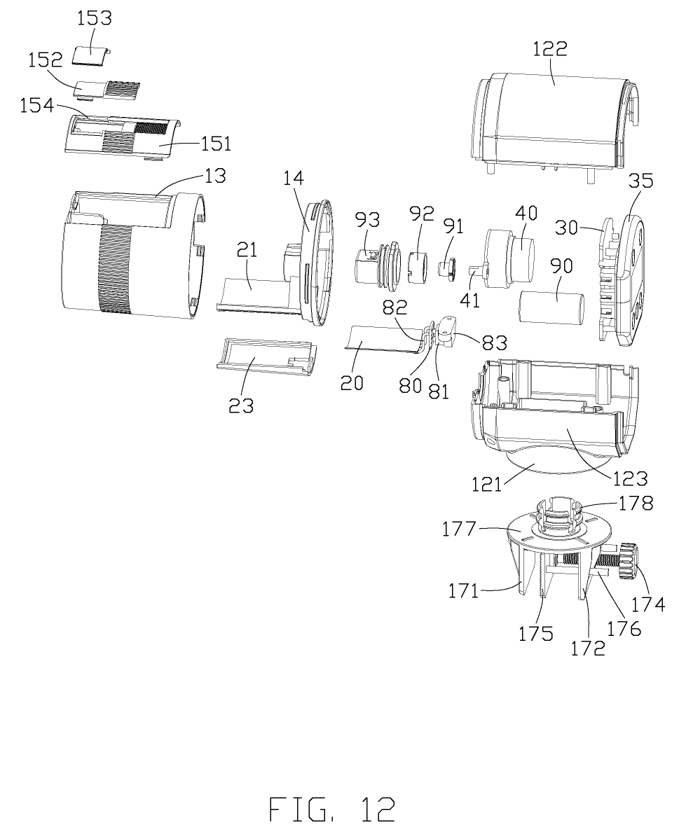

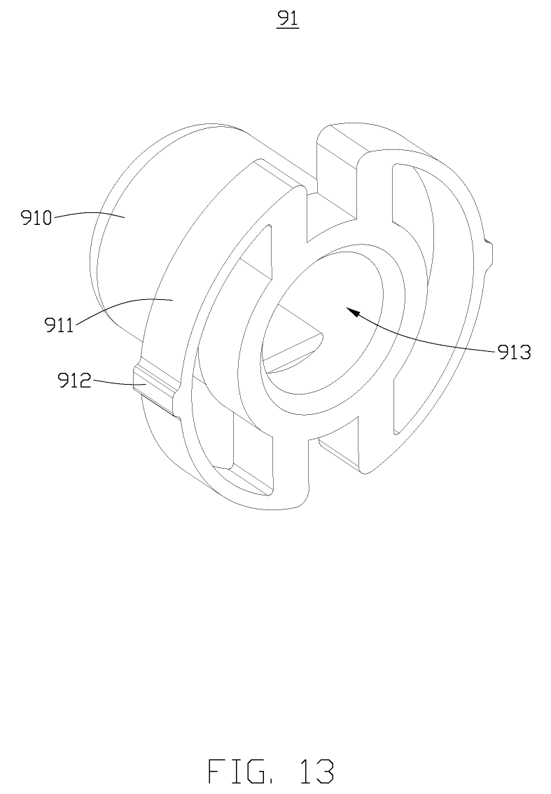

Referring to FIGS. 12 and 13, in this embodiment, the second housing 12 is not a one-piece cylindrical housing but includes an upper case 122 and a lower case 123 that fit together to form an enclosure capable of housing the motor 40, power system 60, controller 30, pogo pin connector 81, etc. Compared to a one-piece main housing, the upper and lower case structure makes installation and maintenance of components inside the second housing 12 more convenient. After fitting, a rear end of the second housing 12 is open and covered by a base cover 35. Moreover, the lower case 123 has a mounting portion 121 on its outer wall. The mount 17, besides including the first clamp plate 171, second clamp plate 172, threaded hole 173, and bolt 174, further includes a pressure plate 175 located between the first and second clamp plates. The pressure plate 175 is slidably connected to the second clamp plate 172 via guide rods 176. The bolt 174 abuts the pressure plate 175. The first and second clamp plates are both fixed on a top plate 177. The top plate 177 also has a pivot post 178 rotatably connected to the mounting portion 121. When installing the device 100 onto a fish tank 200, tightening the bolt 174 causes the first clamp plate 171 and the pressure plate 175 to clamp the wall of the fish tank 200. Force can be applied to rotate the first housing 1 relative to the mount 17 until the outlet 13 is above the water surface, ensuring correct dispensing. When feeding is not required, the first housing 1 can be rotated so the outlet 13 is outside the fish tank 200, thereby reducing the amount of evaporated moisture entering the storing container 10, further avoiding food dampness. To enhance automation, the rotation of first housing 1 relative to mount 17 can be motor-driven, e.g., by providing another motor in the base 12 connected to the controller 30, its output shaft extending from the storing container 10 with a drive gear fixed thereon, engaging a driven gear on the mount 17.

Referring to FIGS. 12 and 13, this embodiment provides a safe and reliable drive connection structure for transmitting power from the motor 40 to the storing container 10, enabling its rotation. Specifically, the drive connection structure includes a first coupling 91, a second coupling 92, and a third coupling 93. The first coupling 91 is sleeved within a cavity of the second coupling 92, which is sleeved within a cavity of the third coupling 93. The third coupling 93 is snap-connected to the end cap 14, which is snap-connected to the first housing 1. The power transmission path is: drive shaft 41 → first coupling 91 → second coupling 92 → third coupling 93 → end cap 14 → the first housing 1. When the load on motor 40 is excessive (beyond its rated range), this structure prevents the drive shaft 41 from jamming, as detailed below.

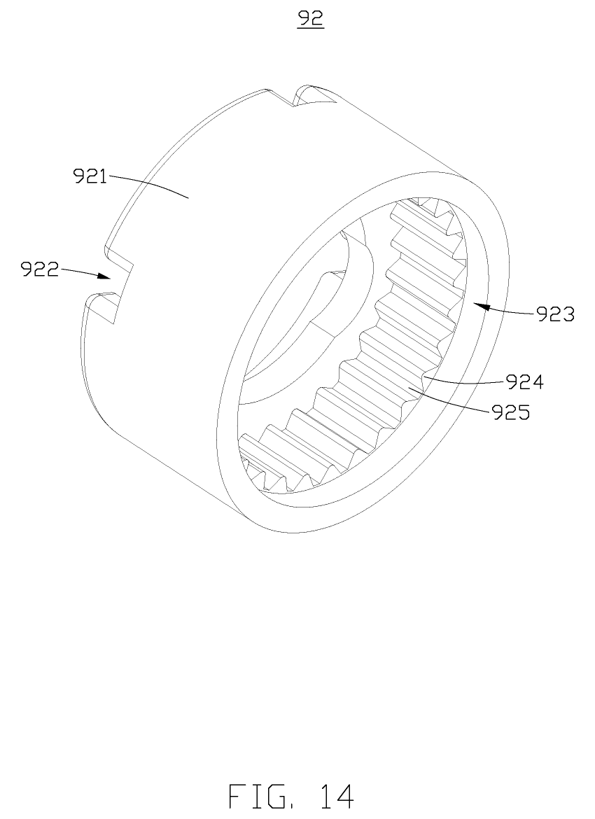

Referring to FIG. 13, the first coupling 91 includes a first cylinder 910 having a first socket 913. The outer wall of the first cylinder 910 has two oppositely arranged first elastic arms 911 provided with first external teeth 912. The first elastic arms 911 are elastic and can deform. Referring to FIG. 14, the second coupling 92 includes a second cylinder 921 having a second socket 923. An inner wall of the second socket 923 is provided with circumferentially distributed second internal teeth 924, with engagement grooves 925 formed between adjacent teeth. The outer wall of the second cylinder 921 has a plurality of second notches 922 circumferentially. The first coupling 91 is sleeved within the second socket 923 of the second coupling 92, and the first external teeth 912 engage the second internal teeth 924, i.e., extending into the grooves 925. Thus, engagement transmits power from the first coupling 91 to the second coupling 92. Moreover, when the motor load is excessive, the contact force between the teeth becomes large, causing the elastic first arms 911 to deform (radially contracting toward the first cylinder 910), disengaging the teeth. Consequently, the drive shaft 41 only drives the first coupling 91 to rotate, avoiding jamming. This connection is safe and reliable. When the load returns to normal, the teeth re-engage, allowing power transmission. Thus, the connection between the first and second couplings is elastic, ensuring safe and reliable power output.

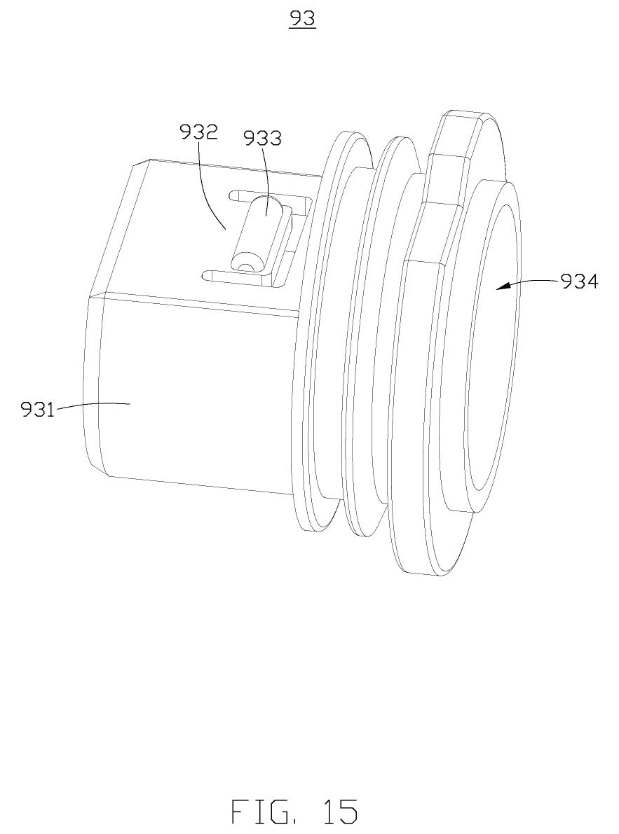

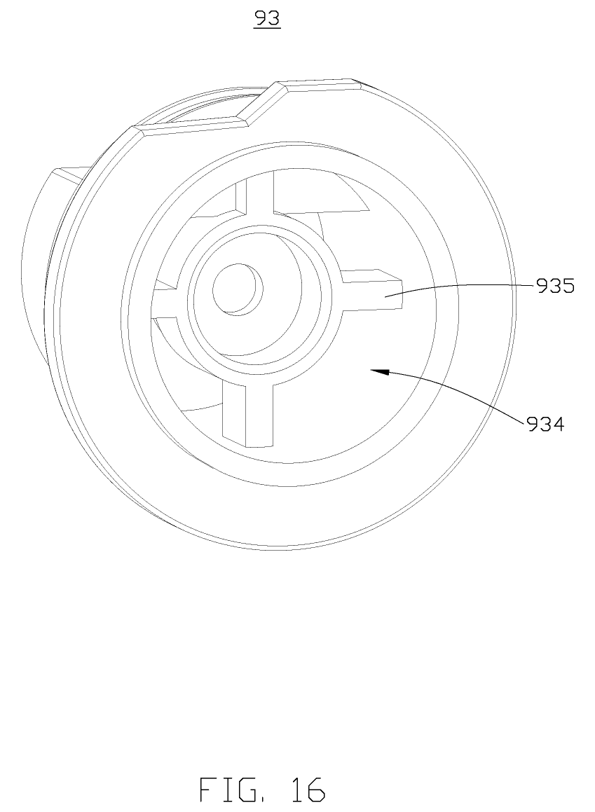

Referring to FIG. 15, the third coupling 93 includes a third cylinder 931 having a third socket 934. The outer wall of the third coupling 93 is formed with latch tabs 932 via slits, each having a third latch 933. Referring to FIG. 16, the third socket 934 is provided with a third latch arm 935. The second coupling 92 is sleeved within the third socket 934, and the second notches 922 engage the third latch arm 935, achieving fixed connection and power transmission from the second coupling 92 to the third coupling 93.

Referring to FIG. 14, the end cap 14 includes an end plate 141. An end face of the end plate 141 facing the storing container 10 has a fourth upper cover plate 21 extending into the interior of the first housing 1. Therefore, the fourth upper cover plate 21 is fixed to the end cap 14 and rotates with it. A central portion of the end plate 141 has a recess 142 whose wall surface is provided with a first slot 143. When the third coupling 93 snap-connects to the end cap 14, the third latch 933 engages the first slot 143, fixing them together, so the third coupling 93 can transmit power to the end cap 14.

Continuing with FIG. 12, in this embodiment, the interior of the first housing 1 also has a fifth lower cover plate 23. The fourth upper cover plate 21 and the fifth lower cover plate 23 are fitted and fixed together, with the heater 20 sandwiched between them. The heater 20 is connected via wires 82 to the connector board 80. Heat generated by the heater 20 first raises the temperature of the fourth upper cover plate 21. Food directly contacting this plate is heated at a rate that is not too fast.

When the first housing 1 rotates to the first state, the connector board 80 contacts the spring pins of the pogo pin connector 81, establishing electrical connection. When in the second state, the connection breaks. In this embodiment, the pogo pin connector 81 is fixedly installed on a mounting block 83, which is fixed inside the base 12.

Similarly, the connector board 80 contacts the pins once per rotation. FIG. 11 shows the first housing 1 in the first state with connection established. When in the second state, the connection is broken.

Furthermore, in this disclosure, relational terms such as "first" and "second" are used merely to distinguish one entity or operation from another, without necessarily requiring or implying any actual such relationship or order between them. Moreover, the term "comprise", "include", or any variation thereof is intended to cover non-exclusive inclusion, such that a process, method, article, or device comprising a list of elements includes not only those elements, but also other elements not explicitly listed, or elements inherent to such process, method, article, or device. Without further limitation, an element defined by the phrase "comprising a..." does not exclude the presence of additional identical elements in the process, method, article, or device that comprises the said element.

All aspects of the embodiments disclosed herein are illustrative and are not to be construed as limiting. Therefore, the technical scope of the present utility model is not limited only to the above embodiments but is defined by the claims. Moreover, all modifications within the meaning and scope equivalent to the claims are included.

What is claimed is:

1. An automatic fish food dispensing device installable on a fish tank for automatically dispensing fish food, the automatic fish food dispensing device comprising:
a storing container configured to store fish food, the storing container comprising a first housing;
a dispensing mechanism configured to control dispensing of the fish food in the storing container, the dispensing mechanism comprising:
a second housing, wherein an interior cavity of the second housing is isolated from an interior cavity of the first housing; and
a power system in the second housing, the power system configured to provide power to the dispensing mechanism; and
a sheet-like heater in the first housing and configured to be isolated from air inside the first housing, wherein the sheet-like heater generates heat to maintain the fish food inside the first housing in a dry condition.

2. The automatic fish food dispensing device according to claim 1, wherein the sheet-like is at least one of a sheet structure constituted by an entire heating sheet, a sheet structure formed by laying heating tubes, and a sheet structure formed by laying heating wires.

3. The automatic fish food dispensing device according to claim 1, wherein the sheet-like heater is configured to fit between an upper cover plate and a lower cover plate.

4. The automatic fish food dispensing device according to claim 1, wherein the first housing comprises an outlet configured for the fish food to flow out; and
the first housing is rotatably connected to the second housing;
in response to the first housing being rotated to a position such that the outlet faces downward, the outlet is unobstructed to cause the fish food to flow out into the fish tank.

5. The automatic fish food dispensing device according to claim 4, wherein the sheet-like heater is arranged opposite to the outlet.

6. The automatic fish food dispensing device according to claim 5, the dispensing mechanism further comprising a controller in the second housing; and
the second housing comprises a pogo pin connector at an end of the second housing facing the first housing, the pogo pin connector is electrically connected to the controller;
the first housing further comprises a connector board at an end of the first housing facing the second housing;
each time the first housing is rotated one turn relative to the second housing, the connector board is electrically connected to the pogo pin connector once, and in response to the connector board being electrically connected to the pogo pin connector, the outlet is driven to face upward.

7. The automatic fish food dispensing device according to claim 6, wherein the sheet-like heater rotates together with the storing container.

8. The automatic fish food dispensing device according to claim 6, wherein the sheet-like heater is adjacent to a wall surface of the first housing.

9. The automatic fish food dispensing device according to claim 6, the controller controls the sheet-like heater at a temperature between 40 °C and 60 °C.

10. The automatic fish food dispensing device according to claim 6, the dispensing mechanism further comprising a motor in the second housing, and the motor is electrically connected to the controller; and
a drive shaft of the motor is connected to the first housing, the first housing is driven to rotate relative to the second housing by the drive shaft.

11. An automatic fish food dispensing device configured to be installed on a fish tank for automatically dispensing fish food, the automatic fish food dispensing device comprising:
a storing container configured to contain fish food, the storing container comprising a first housing;
a dispensing mechanism configured to control dispensing of the fish food from the storing container, the dispensing mechanism comprising:
a second housing connected to the first housing; and
a power system in the second housing, the power system configured to provide power to the dispensing mechanism;
a heater thermally coupled to the first housing and being configured to generate heat to maintain the fish food inside the first housing in a dry condition.

12. The automatic fish food dispensing device according to claim 11, wherein the heater is adjacent to a wall surface of the first housing.

13. The automatic fish food dispensing device according to claim 12, wherein the heater is sheet-shaped.

14. The automatic fish food dispensing device according to claim 13, wherein the heater is configured to be at least covered by an upper cover plate;
the heater is configured to raise temperature of the upper cover plate.

15. The automatic fish food dispensing device according to claim 14, wherein the heater is further configured to be covered by a lower cover plate and sandwiched between the upper cover plate and the lower cover plate.

16. An automatic fish food dispensing device installable on a fish tank for automatically dispensing fish food, the automatic fish food dispensing device comprising:
a storing container configured to store fish food, the storing container comprising a first housing comprising an outlet configured for the fish food to flow out;
a dispensing mechanism configured to control dispensing of the fish food in the storing container, the dispensing mechanism comprising:
a second housing, wherein an interior cavity of the second housing is isolated from an interior cavity of the first housing ; and
a power system in second housing, the power system configured to provide power to the dispensing mechanism;
a heater in the first housing and opposite to the outlet, and configured to generate heat to maintain the fish food inside the first housing in a dry condition.

17. The automatic fish food dispensing device according to claim 16, wherein the first housing is rotatably connected to the second housing;
in response to the first housing being rotated to a position such that the outlet faces downward, the outlet is unobstructed to cause the fish food to flow out into the fish tank.

18. The automatic fish food dispensing device according to claim 17, wherein the dispensing mechanism further comprises a motor in the second housing; and
a drive shaft of the motor is connected to the first housing, the first housing is driven to rotate relative to the second housing by the drive shaft.

19. The automatic fish food dispensing device according to claim 18, wherein the dispensing mechanism further comprises a controller in the second housing; and
the second housing comprises a pogo pin connector at an end of the second housing facing the first housing, the pogo pin connector is electrically connected to the controller;
the first housing further comprises a connector board at an end of the first housing facing the second housing;
each time the first housing is rotated one turn relative to the second housing, the connector board is electrically connected to the pogo pin connector once, and in response to the connector board being electrically connected to the pogo pin connector, the outlet is driven to face upward.

20. The automatic fish food dispensing device according to claim 18, the automatic fish food dispensing device further comprising a first coupling, a second coupling, and a third coupling;
the first coupling comprises a first cylinder comprising a first socket, and a first elastic arm on an outer wall of the first coupling, wherein the first elastic arm comprises first external teeth;the second coupling comprises a second cylinder comprising a second socket, wherein the second socket comprises a plurality of second internal teeth on an inner wall of the second socket, and the second coupling further comprises a second notch on an outer wall of the second coupling;the third coupling comprises a third cylinder comprising a third socket, wherein the third socket comprises a third latch arm, and the third cylinder further comprises a third latch on an outer wall of the third cylinder;wherein the first socket is fixedly connected to the drive shaft of the motor, the first cylinder is sleeved within the second socket, the first external teeth engage the second internal teeth, the second cylinder is sleeved within the third socket, the second notch is connected to the third latch arm, and the third latch is snap-connected to an end cap;wherein the end cap is snap-connected to the first housing.
